(19) United States
(12) Patent Application Publication
(10) Pub. No.: US 2016/0351212 A1
(43) Pub. Date: Dec. 1, 2016

(54) MAGNETIC SENSOR HAVING A WEAK MAGNETIC SPACER

(71) Applicant: HGST Netherlands B.V., Amsterdam (NL)

(72) Inventors: Norihiro Okawa, Kanagawa (JP); Koujiro Komagaki, Kanagawa (JP)

(21) Appl. No.: 14/726,516

(22) Filed: May 30, 2015

(51) Int. Cl. G11B 5/31; G11B 5/39

(52) U.S. Cl. CPC G11B 5/3116; G11B 5/3912

(57) ABSTRACT

A magnetic sensor having improved magnetic free layer stability and signal resolution. The magnetic sensor includes a weak magnetic spacer located between a magnetic free layer and a trailing magnetic shield. The weak magnetic spacer provides a desired weak magnetic coupling between the magnetic free layer and the trailing shield. This weak magnetic coupling reduces signal side lobe, thereby improving signal resolution. The weak magnetic spacer can be an alloy that includes magnetic and nonmagnetic elements. The magnetic elements can be one or more of Co, Fe and Ni. The nonmagnetic elements can be one or more of Hf, Ta, Nb and Zr.

### FIELD OF THE INVENTION

The present invention relates to magnetic data recording and more particularly to a magnetic sensor having a weak magnetic spacer between a free layer and upper shield for improved magnetic free layer stability.

### BACKGROUND

At the heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When current flows through the coil, a resulting magnetic field causes a magnetic flux to flow through the coil, which results in a magnetic write field emitting from the tip of the write pole. This magnetic field is sufficiently strong that it locally magnetizes a portion of the adjacent magnetic media, thereby recording a bit of data. The write field then, travels through a magnetically soft under-layer of the magnetic media to return to the return pole of the write head.

A magnetoresistive sensor such as a Giant Magnetoresistive (GMR) sensor or a Tunnel Junction Magnetoresistive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the magnetic media.

As magnetic sensors become ever smaller in response to the need for ever increased data density, challenges arise with regard to sensor performance and reliability. For example, as sensors become smaller free layer magnetic stability suffers. This instability can disproportionately affect certain portions of the free layer. As an example, the magnetization of the outer edges of the free layer can become unstable even if the magnetic alignment of the free layer as a whole remains generally stable. If the free layer is large, such disturbance of the magnetization of the outer portions of the free layer can be relatively small and tolerable. However, as the free layer becomes very small, this disturbance of the outer edges becomes a larger portion of the overall signal, to the point where its affect on signal resolution becomes intolerable. Therefore, there remains a need for a sensor design that can maintain good free layer magnetic over the entire width of the free layer.

### SUMMARY

The present invention provides a magnetic sensor that includes a magnetic free layer structure, a magnetic shield structure and a weak magnetic coupling layer located between the magnetic free layer and the magnetic shield structure.

The weak magnetic coupling layer can be an alloy that includes magnetic and non-magnetic elements. The magnetic elements can be one or more of Co, Fe and Ni and the non-magnetic elements can be one or more of Hf, Ta, Nb and Zr. For example, the non-magnetic spacer can be formed of CoFeBTa, and can have a Ta content of between 21.5 and 29.5 atomic percent.

In addition, a magnetic capping layer such as NiFe can be formed above the weak magnetic spacer layer. The presence of the weak magnetic spacer advantageously provides a weak magnetic coupling between the magnetic free layer and the magnetic shield. This weak magnetic coupling helps to control the magnetic domains of the magnetic free layer in a desirable manner while also allowing the magnetic free layer to respond to an external magnetic field, such as from a magnetic media.

These and other features and advantages of the invention will be apparent upon reading of the following detailed description of the embodiments taken in conjunction with the figures in which like reference numeral indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is a schematic view of a magnetic sensor according to an embodiment as seen from the media facing surface;

FIG. 3 is a schematic view of a magnetic sensor according to another embodiment as viewed from the media facing surface;

FIG. 4 is an enlarged view of a portion of the sensor such as according to embodiments of FIGS. 2 and 3 shown in an intermediate stage of manufacture;

FIG. 5 is a graph showing signal amplitude as a function of off-track location;

FIG. 6 is a graph showing coupling field as a function of spacer layer thickness for a sensor having a non-magnetic spacer and a sensor having a weak magnetic spacer;

FIG. 7 is a graph showing coupling field as a function of Ta content for a sensor having a CoFeBTa spacer;

FIG. 8a is a hysteresis curve for a conventional sensor having no coupling between the free layer and the upper magnetic shield; and

FIG. 8b is a hysteresis curve for a sensor having a weak magnetic spacer layer that provides magnetic coupling between the free layer and the upper magnetic shield.

### DETAILED DESCRIPTION

The following description is of the best embodiments presently contemplated for carrying out this invention. This description is made for the purpose of illustrating the general principles of this invention and is not meant to limit the inventive concepts claimed herein.

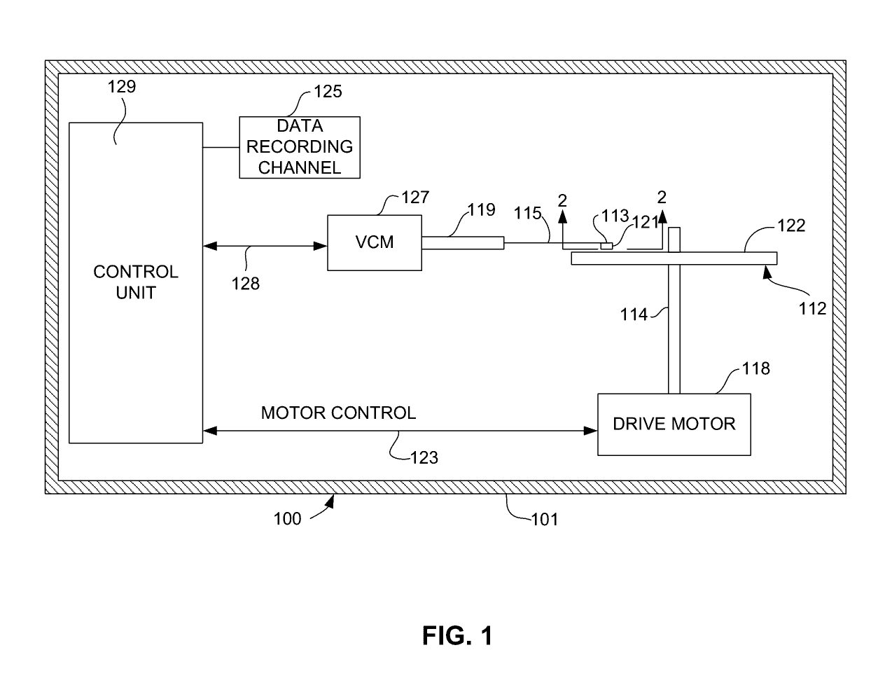

Referring now to FIG. 1, there is shown a disk drive 100. The disk drive 100 includes a housing 101. At least one rotatable magnetic disk 112 is supported on a spindle 114 and rotated by a disk drive motor 118. The magnetic recording on each disk may be in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases the slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by the controller 129.

During operation of the disk storage system, the rotation of the magnetic disk 112 generates an air bearing between the slider 113 and the disk surface 122, which exerts an upward force or lift on the slider. The air bearing thus counter-balances the slight spring force of the suspension 115 and supports the slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, and a microprocessor. The control unit 129 generates control signals to control various system operations such as drive motor control signals on line 123 and head position and seek control signals on line 128. The control signals on line 128 provide the desired current profiles to optimally move and position the slider 113 to the desired data track on the media 112. Write and read signals are communicated to and from write and read heads 121 by way of recording channel 125.

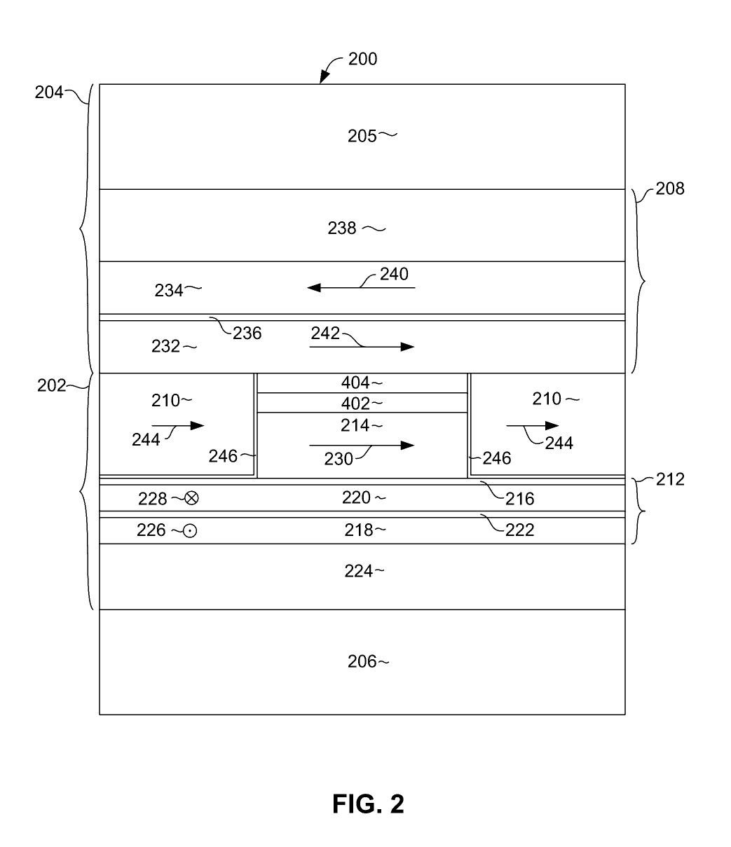

With reference to FIG. 2, a magnetic sensor 200 includes a sensor stack 202 sandwiched between upper (trailing) and lower (leading) magnetic shields 204, 206. The upper magnetic shield 204 can include a structure 208 that functions as a magnetic bias structure, and also a can include a soft magnetic layer such as NiFe 205 above the bias structure 208. The sensor 200 can also include soft magnetic side bias structures 210, which will be discussed in further detail herein below.

The sensor stack 202 can include a magnetic pinned layer structure 212, a magnetic free layer structure 214 and a non-magnetic spacer or barrier layer 216 sandwiched between the magnetic pinned layer structure 212 and magnetic free layer structure 214. If the sensor 200 is a giant magnetoresistive sensor (GMR) then the non-magnetic layer 216 is a non-magnetic, electrically conductive spacer layer such as Cu. On the other hand, if the sensor 200 is a tunnel junction magnetoresistive sensor (TMR), then the layer 216 is a non-magnetic electrically insulating barrier layer. The sensor stack 202 also includes a novel weak magnetic spacer layer 402 and may include a magnetic capping layer 404 formed over the weak magnetic spacer layer 402 such that the capping layer 404 is between the weak magnetic spacer layer 402 and the upper shield structure 204, and the weak magnetic spacer layer 202 is between the magnetic free layer 214 and the capping layer 204. The purpose and function of the weak magnetic spacer layer 402 and the magnetic capping layer 404 will be described in greater detail herein below.

The pinned layer structure 212 can be an anti-parallel coupled pinned layer structure that includes first and second magnetic layers 218, 220 that are anti-parallel coupled across a non-magnetic anti-parallel coupling layer such as Ru 222 located between the first and second magnetic layers 218, 220. The first magnetic layer 218 can be exchange coupled with a layer of antiferromagnetic material (AFM) such as IrMn 224. This exchange coupling causes the first magnetic layer 218 to have a magnetization that is strongly pinned in a first direction perpendicular to the media facing surface as indicated by arrow head symbol 226. The anti-parallel coupling between the first and second magnetic layers 218, 220 causes the magnetization of the second layer 220 to be strongly pinned in a direction that is opposite to the first direction as indicated by arrow tail symbol 228.

The free magnetic layer structure 214 has a magnetization that is biased in a direction that is generally parallel with the media facing surface as indicated by arrow symbol 230. While this magnetization 230 is biased in a direction that is generally parallel with the media facing surface as shown, it is free to move in response to an external magnetic field such as a magnetic field from a magnetic media (not shown in FIG. 2).

The magnetization 230 of the magnetic free layer 214 is biased in the desired orientation by a magnetic bias field from the upper magnetic bias structure 208 and soft magnetic side bias structures 210. The upper magnetic bias structure 208 can include first and second magnetic layers 232, 234 and a non-magnetic anti-parallel coupling layer 236 sandwiched between the first and second magnetic layers 232, 234. A layer of antiferromagnetic material 238 can be formed above and exchange coupled with the second magnetic layer 234. This exchange coupling pins the magnetization of the second magnetic layer 234 in a first direction parallel with the media facing surface as indicated by arrow 240. Anti-parallel coupling between the first and second magnetic layers 232, 234 pins the magnetization of the first magnetic layer 232 in a direction that is opposite to that of the second layer 232 as indicated by arrow symbol 242. The upper bias structure 208 can be considered to be a part of the upper shield 204 having its magnetic domain set by the layer of antiferromagnetic material 238.

The magnetic layer 232 of the upper bias structure 208 is in contact with and magnetically coupled with the first and second side bias structures, which can be soft magnetic side shields 210. This causes the magnetization of the side bias structures 210 to have magnetizations that are pinned in the same direction as the layer 232 as indicated by arrows 244. Each of the magnetic bias structures 210 can be separated from the sensor stack 202 by an electrically insulating layer such as alumina 246 in order to prevent shunting of sense current through the side bias structures 210.

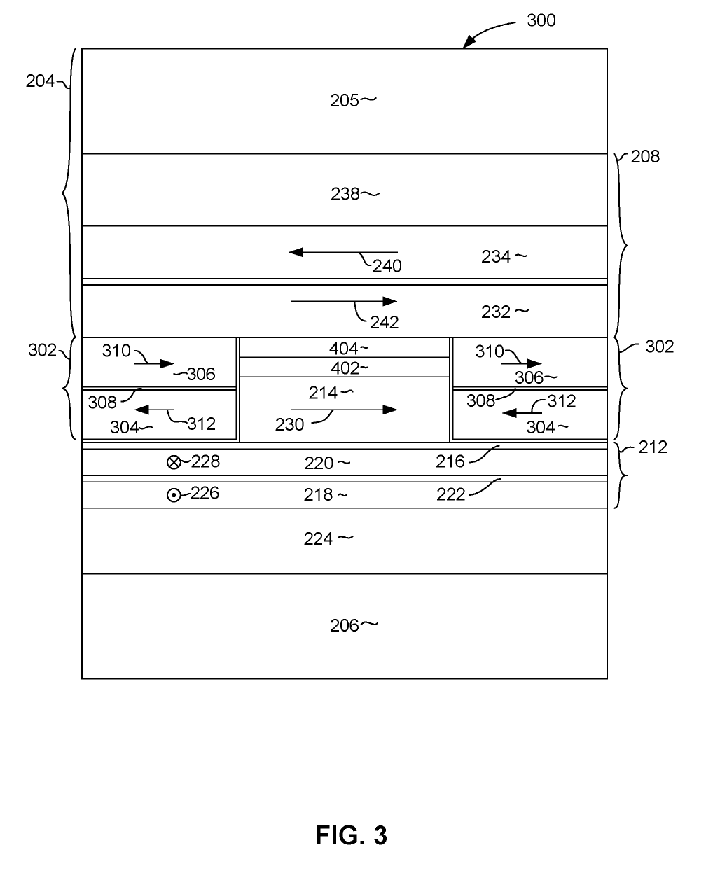

With reference to FIG. 3, an alternate embodiment of a sensor 300 includes an anti-parallel coupled side bias structure 302. Other elements and structures can be similar to those described above with reference to FIG. 2. Each of the anti-parallel coupled side bias structures 302 can include first and second soft magnetic layers 304, 306 that are antiparallel coupled across a non-magnetic anti-parallel coupling layer 308. One of the magnetic layers (in this case 304) is more closely aligned with the free layer 214 than is the other magnetic layer 306 so that it can provide a magnetic bias field for assisting the biasing of the free layer structure 214. The upper magnetic layer 306 can be exchange coupled with the magnetic layer 232, which causes the magnetization of the layer 306 to be pinned in the same direction as the layer 232 as indicated by arrow 310. The antiparallel coupling between the layers 304, 306 causes the magnetization of the layer 304 to be pinned in an opposite direction as indicated by arrow 312. This embodiment can be useful in that the anti-parallel coupling between layers 306, 304 helps to maintain the desired magnetic orientations of the side bias layer structures 302.

As can be seen with reference to FIGS. 2 and 3, the biasing of the magnetization 230 of the free layer 214 is provided by magnetic bias fields from both the magnetic layer 232 of the upper bias structure 208 as well as the magnetic side bias structures 210 (302 for FIG. 3). In order to control magnetic bias fields from the upper bias structure 208, the free layer 214 and layer 232 must be weakly coupled.

This weak coupling can be carefully controlled by the novel weak magnetic spacer layer structure 402. The weak magnetic spacer layer structure 402 is formed on the magnetic free layer structure 214 between the magnetic free layer structure 214 and magnetic capping layer 404. The presence of the magnetic capping layer structure 404 protects the underlying weak magnetic spacer from damage and acts as a diffusion barrier during manufacture of the magnetic sensor 200 as will be described in greater detail herein below.

In order for the sensor 200 (or 300 in FIG. 3) to function properly, it is desirable that the upper bias structure 208 provide just the right amount of magnetic biasing to the free layer structure 214. This means that the amount of magnetic coupling between the upper bias structure 208 and free layer structure 214 should be carefully controlled. If too much coupling exists, the free layer will be pinned and the resulting signal will be weak to non-existent. On the other hand, if insufficient magnetic coupling exists between the upper bias structure 208 and the free layer structure 214, the free layer will be unstable, and the magnetic signal will include excessive signal noise. A non-magnetic de-coupling layer such as Ta could be used in place of the weak magnetic spacer 402. However, this would require that such a non-magnetic space be very thin, in order to provide sufficient magnetic biasing of the free layer 214. The thickness and resulting magnetic coupling would be very difficult to control in practice and reliability and sensor performance would, therefore, suffer.

The inventors have found that the use of the magnetic spacer 402 having weak magnetic properties provides significant weak magnetic coupling controllability advantages. This advantage in using a weak magnetic spacer 402 is surprising and unexpected, because one skilled in the art would expect that the use of a magnetic coupling layer (even one with weak magnetic properties) would result in direct magnetic coupling between the magnetic free layer structure 214 and the upper bias structure 208 and that that the amount or strength of magnetic coupling could not be controlled.

The weak magnetic spacer 402 is preferably a material having a magnetic flux density of less than 0.4 T, but greater than zero. More preferably, the weak magnetic spacer 402 has a magnetic flux density of between 0.05 Tesla and 0.4 Tesla. The weak magnetic spacer 402 can be formed of a material that contains both magnetic and non-magnetic elements in a ratio that provides the desired magnetic flux density. The weak magnetic spacer 402 can be formed of a material such as CoFeBTa. Other materials could be used for the weak magnetic spacer 402 as well, such as CoHf, CoFeHf, CoNiFeHf, CoFeBHf, CoTa, NiTa, CoNb, NiNb, CoZr or NiZr with such materials having their various elements in a ratio that results in the magnetic spacer having a magnetic flux density that is less than 0.4 T but greater than 0 T (or more preferably 0.05 to 0.4 T).

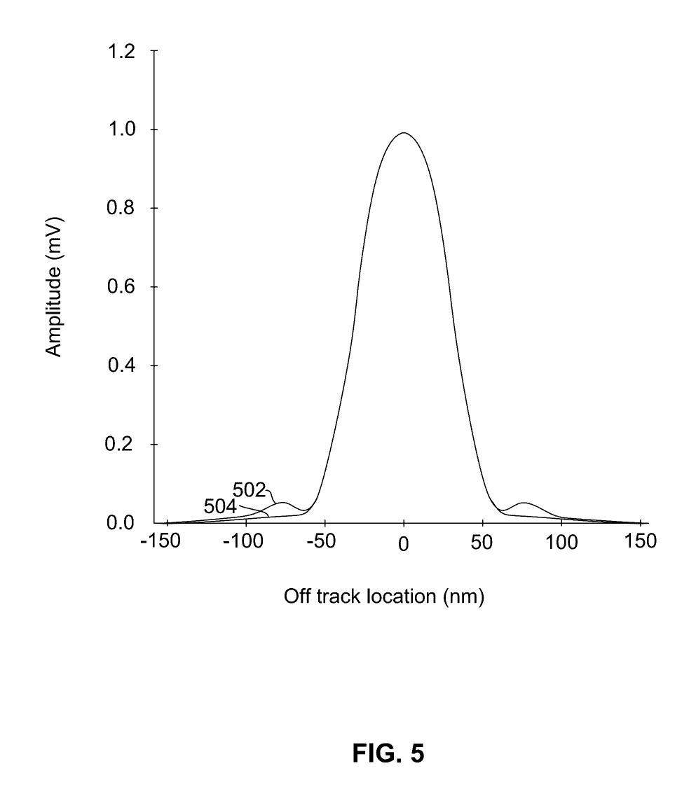

In a conventional magnetic sensor, the free layer is completely magnetically decoupled from the upper magnetic shield. This magnetic decoupling is achieved through the use of a thick, non-magnetic capping layer. A problem that arises with such a structure, is that the outer edges of the free layer can become magnetically unstable. This magnetic instability can result from local magnetization of the side magnetic side shields that alters the magnetic domains of the edges of the free layer. FIG. 5 shows the results of such magnetic instability. FIG. 5 shows the signal amplitude of as sensor along the cross track direction (off track direction) in nanometers (nm). Line 502 shows the signal amplitude for a sensor wherein the free layer is magnetically decoupled from the upper shield, and line 504 shows the signal amplitude for a sensor having the weak magnetic coupling described above. As can be seen, the sensor having the de-coupled free layer has a side lobe in its signal response. This is a result of undesired magnetic domain movement at the outer edge of the free layer. These outer signal lobes degrade the signal resolution of the sensor. The embodiments described above prevent such side lobes by maintaining stable magnetic domains in the free layer across the entire width of the free layer.

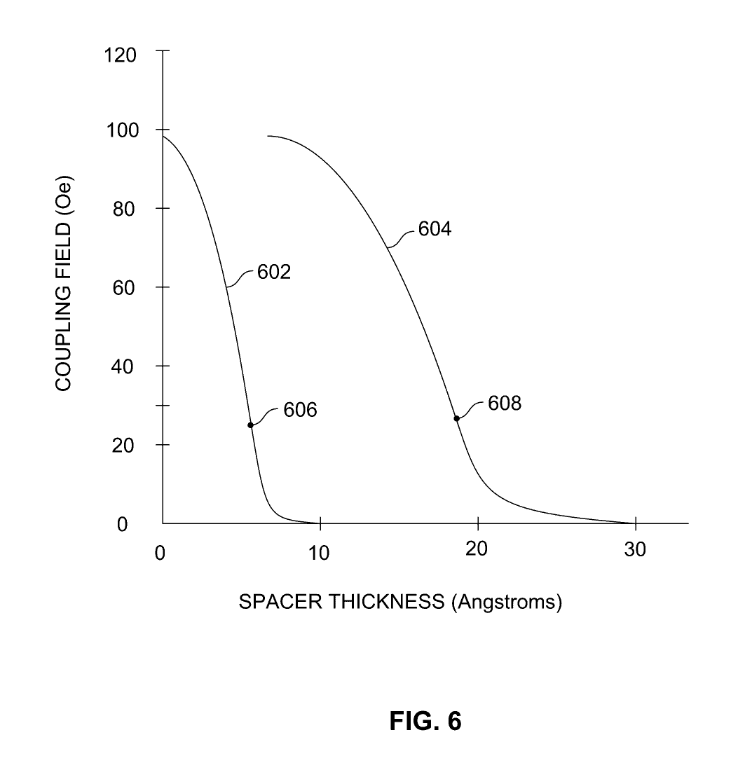

As discussed above, the desired magnetic coupling field between the free layer and bias/shield can be achieved by using a very thin non-magnetic spacer. However, because the non-magnetic spacer would have to be extremely thin, such a structure would be difficult to achieve in a manner that would result in a well controlled magnetic coupling. FIG. 6 shows the relationship between spacer thickness and magnetic coupling for a sensor having a non-magnetic spacer and a sensor having a weak magnetic spacer. Line 602 shows the coupling field vs. spacer thickness relationship for a sensor having a non-magnetic spacer and line 604 shows the relationship between coupling field and spacer thickness for a sensor having a weak magnetic spacer as described above. It can be seen that to achieve the desired magnetic coupling of about 25 Oe, (at point 606) the non-magnetic spacer would have to very thin (less than 5 Angstroms thick). On the other hand, when a weak magnetic spacer is used the desired magnetic coupling of about 25 Oe can be achieved with a spacer that is over 15 Angstroms thick (at point 608). This thicker spacer is much easier to manufacture in a controllable and reliable manner.

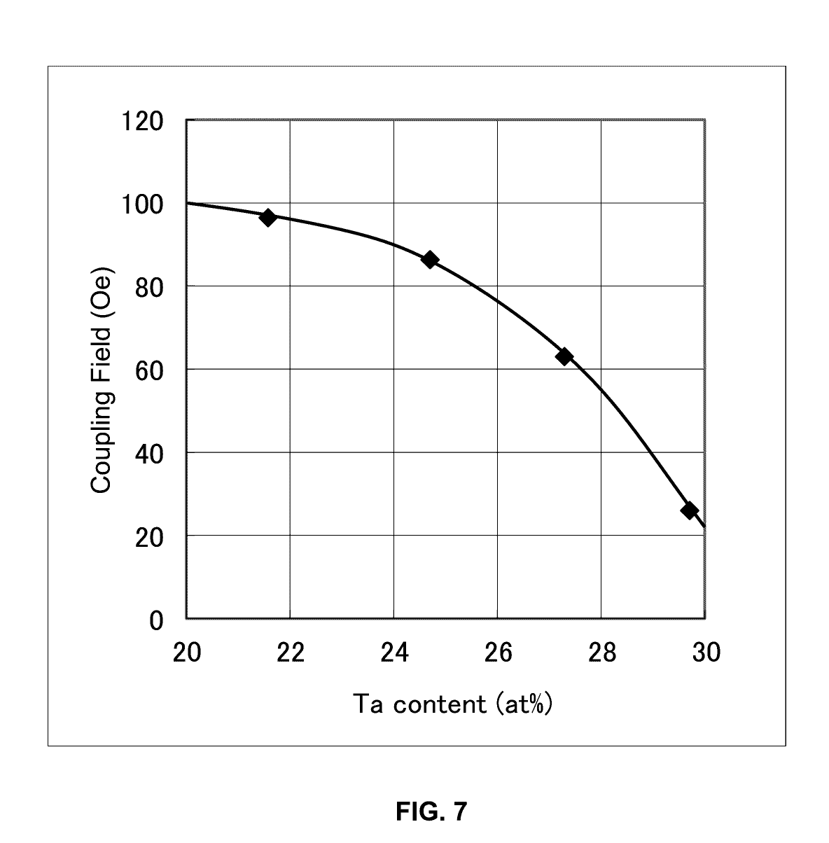

As discussed above, the amount of magnetic coupling between the free layer 214 and upper shield/bias layer 232 can be controlled by varying the composition of the weak magnetic spacer 402 (FIGS. 2, 3). The weak magnetic spacer can be constructed of an alloy of magnetic and non-magnetic materials, and the magnetic coupling can be adjusted by adjusting the amount of non-magnetic material. For example, FIG. 7 shows the coupling field as a function of Ta content for a sensor having a weak magnetic spacer formed of CoFeBTa. As can be seen, the magnetic coupling decreases with increasing Ta content. A magnetic flux density from 0.05 T to 0.4 T, which corresponds with a Ta content of 21.5 to 29.5 atomic percent, results in a coupling field of more than 25 Oe without resolution deterioration.

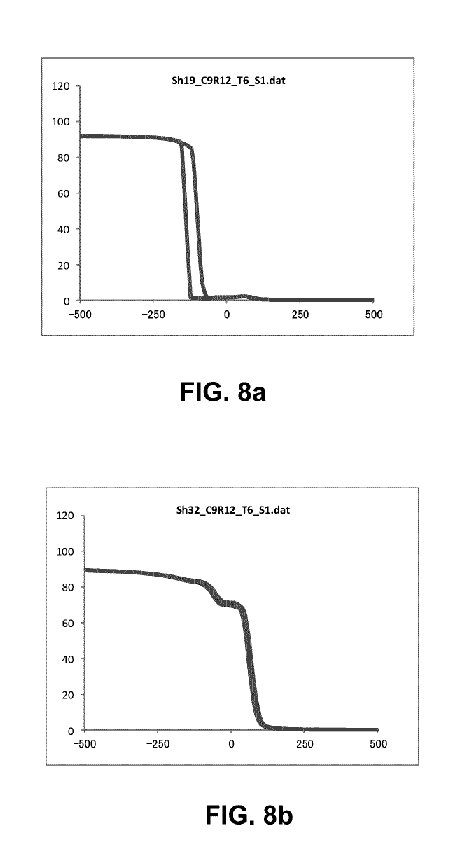

In addition, with reference to FIGS. 8a and 8b, the magnetic coupling provided by the weak magnetic spacer described above results in a better hysteresis curve when compared with a conventional sensor having no magnetic coupling at all. FIG. 8a shows the hysteresis curve for a conventional sensor having no magnetic coupling between the free layer and the upper shield. FIG. 8b shows the hysteresis curve for a sensor as described above having weak magnetic coupling between the free layer and the magnetic shield as a result of the use of a weak magnetic spacer layer. As can be seen, the conventional sensor has a much larger hysteresis, than the sensor having the weak magnetic spacer.

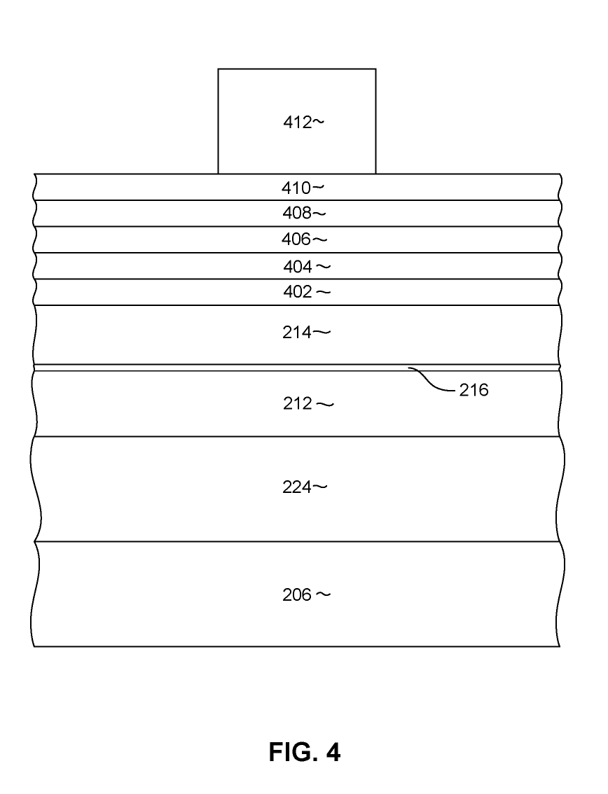

FIG. 4 shows a magnetic sensor in an intermediate stage of manufacture. As shown in FIG. 4, the various sensor stack layers 224, 212, 216, 214, 402 are deposited full film over the bottom shield structure 206. A series of capping layers 404, 406, 408, 410 are then deposited over the sensor stack layers 224, 212, 216, 214, 402, to act as protective layers and as diffusion barrier layers. Each of the sensor stack layers 224, 212, 216, 214, 402 and the capping layers 404, 406, 408, 410 can be deposited in-situ in a common deposition tool by changing sputtering targets. A mask 412 is formed over the above deposited layer. The mask 412 can include a photolithographically patterned photoresist and may include other layers as well such as, as release layer, a bottom anti-reflective coating layer and an image transfer layer (not shown). The mask 412 is configured to define a sensor dimension such as a track width or stripe height. Although only one mask 412 is shown in FIG. 4, the actual manufacture of a sensor can include multiple masking and milling steps to define both the track width and stripe height of the sensor. After the mask 412 is formed, a material removal process such as ion milling and or reactive ion etching can be performed to remove portions of the sensor layer (e.g. free layer 214) that are not protected by the mask in order to define the desired sensor dimension.

In addition to the above described masking and milling operation or operations, other processes can be performed as well, such as a high temperature annealing to set the magnetization of the pinned layer structure 212. The presence of the capping layers 402, 404, 406, 408, 410 protects the free layer 214 during these milling and annealing processes by protecting the free layer 214 from direct damage and by preventing element diffusion into or out of the free layer 214. These processes are performed in such a manner that all of the layers 410, 408, 406 and possibly a portion of layer 404 are removed so that only the NiFe protective cap layer 404 remains over the weak magnetic spacer 402. In this way, the magnetic layer 404 remains to protect the weak magnetic spacer 402 and also to provide direct magnetic coupling with the bias structure 208 (FIGS. 2 and 3).

While various embodiments have been described above, it should be understood that they have been presented by way of example only and not limitation. Other embodiments falling within the scope of the invention may also become apparent to those skilled in the art. Thus, the breadth and scope of the invention may also become apparent to those skilled in the art. Thus, the breadth and scope of the inventions should not be limited by any of the above-described exemplary embodiments, but should be defined only in accordance with the following claims and their equivalents.

1. A magnetic sensor, comprising:
a magnetic free layer structure;
a magnetic shield structure; and
a weak magnetic spacer located between the magnetic free layer structure and the magnetic shield structure, wherein the weak magnetic spacer has a magnetic flux density of 0.05 Tesla to 0.4 Tesla.

2. (canceled)

3. The magnetic sensor as in claim 1 further comprising a magnetic capping layer structure located between the weak magnetic spacer and the magnetic shield structure.

4. The magnetic sensor as in claim 3, wherein the magnetic capping layer structure comprises NiFe.

5. The magnetic sensor as in claim 1, wherein the shield structure is a trailing magnetic shield structure.

6. The magnetic sensor as in claim 1, wherein the magnetic shield structure includes a layer of magnetic material that has its magnetic domain pinned.

7. The magnetic sensor as in claim 1 wherein the weak magnetic spacer comprises an alloy containing a magnetic element and a non-magnetic element.

8. The magnetic sensor as in claim 1 wherein the weak magnetic spacer comprises an alloy containing at least one of Co, Fe and Ni and at least one of Hf, Ta, Nb, and Zr.

9. The magnetic sensor as in claim 1 wherein the weak magnetic spacer comprises CoFeBTa, with a Ta content of between 21.5 atomic percent and 29.5 atomic percent.

10. The magnetic sensor as in claim 1 wherein the magnetic shield structure is a trailing magnetic shield and further comprising a soft magnetic side shield structure that is magnetically coupled with the trailing magnetic shield.

11. The magnetic sensor as in claim 10 wherein the magnetic side shield structure includes first and second magnetic layers that are anti-parallel coupled with one another.

12. The magnetic sensor as in claim 1 wherein the magnetic shield structure includes a magnetic layer and a layer of antiferromagnetic material exchange coupled with the magnetic layer so as to set the magnetic domain of the magnetic layer in a desired direction.

13. The magnetic sensor as in claim 1 wherein the magnetic shield structure includes first and second magnetic layers that are magnetically anti-parallel coupled across a non-magnetic anti-parallel coupling layer and a layer of antiferromagnetic material that is exchange coupled with the second magnetic layer.

14. A magnetic data recording system, comprising:
a housing;
a magnetic media held within the housing;
a slider;
an actuator connected with the slider for moving the slider adjacent to a surface of the magnetic media; and
a magnetic sensor formed on the slider, the magnetic sensor further comprising:
a magnetic free layer structure;
a magnetic shield structure; and
a weak magnetic spacer located between the magnetic free layer structure and the magnetic shield structure; wherein the weak magnetic spacer has a magnetic flux density of 0.05 Tesla to 0.4 Tesla.

15. (canceled)

16. The magnetic data recording system as in claim 14 further comprising a magnetic capping layer structure located between the weak magnetic spacer and the magnetic shield structure.

17. The magnetic data recording system as in claim 14 wherein the weak magnetic spacer comprises an alloy containing a magnetic element and a non-magnetic element.

18. The magnetic data recording system as in claim 14 wherein the weak magnetic spacer comprises an alloy containing at least one of Co, Fe and Ni and at least one of Hf, Ta, Nb, and Zr.

19. The magnetic data recording system as in claim 14 wherein the weak magnetic spacer comprises CoFeBTa, with a Ta content of between 21.5 atomic percent and 29.5 atomic percent.

20. The magnetic data recording system as in claim 16 wherein the magnetic capping layer structure comprises NiFe.
